(19) United States
(12) Patent Application Publication
(10) Pub. No.: US 2025/0153700 A1
(43) Pub. Date: May 15, 2025

(54) BRAKE LOAD MEASURING DEVICE FOR AN ELECTRIC MOTOR-VEHICLE-WHEEL BRAKE, METHOD FOR PRODUCING SAME, AND ELECTRIC MOTOR-VEHICLE-WHEEL BRAKE COMPRISING A BRAKE LOAD MEASURING DEVICE

(71) Applicant: Continental Automotive Technologies GmbH, Hannover (DE)

(72) Inventors: Matthias Schulitz, Frankfurt am Main (DE); Hans-Jörg Feigel, Rosbach v.d.H. (DE); Christian Vey, Petersberg (DE)

(73) Assignee: Continental Automotive Technologies GmbH, Hannover (DE)

(21) Appl. No.: 18/838,320

(22) PCT Filed: Feb. 13, 2023
(86) PCT No.: PCT/DE2023/200031

§ 371 Date: Aug. 14, 2024

(30) Foreign Application Priority Data
Feb. 14, 2022 (DE) 10 2022 201 513.4
Nov. 28, 2022 (DE) 10 2022 212 689.0

(51) Int. Cl. B60T 17/22; F16D 51/22; F16D 65/22; F16D 66/00; F16D 121/24; G01L 5/28

(52) U.S. Cl. CPC B60T 17/22; F16D 65/22; F16D 66/00; G01L 5/28; F16D 51/22; F16D 2066/003; F16D 2121/24; F16D 2250/0084

(57) ABSTRACT

A brake load measuring device of a motor vehicle brake, has a brake load sensor inserted centrally as an integral piston stop into a receiving cross bore of a housing in alignment between the pistons in the receiving cross bore. The brake load sensor is inserted in such a way that the pistons are seated in alignment with each other diametrically opposite each other on both sides of the brake load sensor. In an embodiment, a decoupled structure with a distanced offset is proposed for the protection of the load sensing system.

### TECHNICAL FIELD

A brake load measuring device for an electric motor vehicle wheel brake of the friction brake type and, furthermore, to a corresponding electric motor vehicle wheel brake comprising the brake load measuring device.

### BACKGROUND

A brake load measuring device with an optical brake load sensor system used for a vehicle brake is specified in EP 0 388 040 A2. To this end, the vehicle brake has a fixed, braking force-absorbing part (brake stator), which carries at least one friction element and an actuating member, which is suitable and intended for pressing the friction element into braking engagement with a rotatable brake surface (brake rotor), and wherein a deflectable means is defined, which is arranged in the force transmission path between the friction element and the brake stator in such a way that it is exposed to the load that passes through the friction element during braking, and wherein the deflectable means is deflected by the brake load. Furthermore, the vehicle brake is connected via two optical fiber cables to an electronic unit arranged at a distance, and wherein an optical fiber cable serves for a light-emitting diode in the electronic unit to irradiate the deflectable means of the vehicle brake. A radiation part reflected, or deflected, in a load-dependent manner is reported back to the electronic unit via the other optical fiber cable, which electronic unit has electrical brake load sensors to output an electrical output signal for further use in a vehicle system. As a result, the correct electrical functionality of the discretely constructed measuring system can accordingly be checked for the first time when all components have been assembled in the assigned motor vehicle (therefore at a vehicle manufacturer).

A special motor vehicle drum brake with defined inserted bearing elasticity in the area of a brake shoe support is apparent from DE 10 2018 202 261 A1.

A special measuring abutment construction is apparent from DE 10 2020 133 109 A1. This comprises, as a component which can be deformed in a bending manner, an arm which is arranged elastically resiliently and in the manner of a bending beam between an abutment base and an abutment head, and wherein, starting from the abutment head, there is an integrally mounted measuring rod in the direction of the base, which is equipped with an end-side signal transmitter. Below the abutment base is a separately attached brake load sensor assembly with a signal receiver, which cooperates with the signal transmitter of the measuring rod.

WO 2020/239586 A1 describes a brake load measuring device for a drum brake with a different measuring principle. Here, the abutment has a cylindrical housing with a receiving cross bore, in which two pistons are guided relatively movably. A bottom is provided centrally in the receiving cross bore, wherein each piston is supported by in each case one spring on the bottom, and the two sensing operations of the pistons are each deaxially outside the alignment and decentralized.

### SUMMARY

An object of providing a drum brake and a load measuring principle on the basis of a constructively variably and yet robustly designed brake load measuring device, which promises an improved production, logistics and assembly at favorable interfaces, and wherein, in addition, sufficiently precise measurement data can be obtained with justifiably reasonable complexity.

The term brake load measuring may refer equally to wheel braking force or wheel braking torque-depending on what is preferred for the respective application in the regular operation of a service brake. The following description is therefore intended to essentially refer to an effectively measured service braking torque. A brake load measuring device can receive and/or mount an electrical load measuring component integrally and for example centrally. The brake load measuring device may have an electrical plug-in interface component for the electrical connection of the load measuring component to a vehicle electrical system.

The brake-side plug-in interface component can at least partially engage through a through hole in a brake stator. In configuration as a plug-through interface, this may be designed in the form of a socket, and wherein a frame of the socket (female component) may engage through a through opening in a brake mount, anchor plate, mud guard or similar brake enclosure element from the inside to the outside in the direction of the ambient atmosphere. In an even more detailed embodiment, it may be defined that the socket has a pair of electrical terminal tabs for pairing with a vehicle-side pair of associated connector plugs (male component) of an on-board power wiring harness as the associated plug-in interface component. A reversed allocation of male and female components is also possible to form a different wired or corded interface configuration.

An electric brake load measuring device may therefore be arranged as an easy-to-handle structural unit that can be connected directly to an electric vehicle system without media interruption/media change, and wherein the functionality of the individual wheel measuring unit is electrically verifiable for example labor-sharing industrial production (in the case of a component supplier company) without having to carry out a complete brake system assembly for component testing. Accordingly, the embodiments define for the first time a novel, modern modular design in conjunction with electrical load sensors.

The embodiments also relate to a wheel brake of the friction type with in the broadest sense an electric brake load measuring device. All friction brakes comprise rotatable components (brake rotor, i.e. brake disk, brake drum, or the like) and non-rotatable, i.e. vehicle-mounted components (brake stator, i.e. brake carrier, brake anchor plate, or the like). The wheel brake may therefore generally be designed as a disk brake or drum brake, and in the case of drum brakes, a simplex type or servo brake type may be present. It is possible that the drum brake is present as a multi-mode or dual-mode drum brake, which, for example, can assume different operating modes in a switchable or function-related manner. The motor vehicle drum brake may be present as a service brake or embodied as a combined drum brake, which in addition to the service brake function continues to perform a parking brake function.

Each motor vehicle drum brake comprises, as rotor, a brake drum and two non-rotational, spreadable brake shoes that can be applied to the brake drum. The brake shoes can be held non-rotationally on one side of the brake shoe of an anchor plate. Brake shoes can each have a first and a second end which have supports or lugs, wherein at least one spreading device can be located between first ends of the brake shoes, and at the same time a so-called abutment can be formed with the spreading device, on which abutment said supports/lugs can be supported non-rotationally. Between the second ends, a floating-mounted transmission means and/or an automatic length-adjustable telescopic device (brake wear adjustment device) may be present.

In the case of a drum brake, such as a duo servo drum brake for example, there may be brake shoes received in a brake drum adjustably in a floating manner. This exploits the effect that an annularly self-contained power flow circuit (comparable to a positive wedge between the two brake shoes) is present within the wheel brake, if starting from a stator-fixed actuator an actuating force is initiated via the directly actuated brake shoe, which consequently passes to the brake drum system in order to press the brake shoe onto the brake drum in the case of compression strut support on the indirectly actuated brake shoe until this “internal” flow of force closes in order to close the circuit via the stator-fixed allocated abutment in/on the brake stator. The result is, in a sense, automatic de-energized wedging, which is sought after for parking brake purposes. Constructive internal transmission acts with a self-boosting effect, with the result that the wheel brake is automatically wedged with increasing clamping force in the event of an increasing tendency to roll away, without the need for additional actuator force for this purpose. Depending on the direction of rotation of the rotor, i.e. the direction of drum rotation of the wheel brake to be braked, this places a primary stress on one side or another. A brake load measuring device now provides to determine braking forces or braking torques during operation and/or parking braking for the purpose of controlling electrical service brake interventions and/or electrical parking brake interventions. Accordingly, the embodiments are equally suitable and intended for pure service brakes, for pure parking brakes as well as in principle for so-called combined brakes which include combined electric service brakes and electric parking brakes. It goes without saying here that instead of a all-electric service brake actuator, an electro-hydraulic service brake actuator may in principle also be present without departing from the actual core concept. The brake load measuring device can be designed at the same time as a brake shoe abutment, as well as cooperating with the sensor device, which serves to determine the forces acting on the integral abutment during braking.

The brake load measuring device may have at least one housing component with a bearing block function which is substantially rigidly inserted. The housing component can be allocated substantially centrally between brake shoes. The housing component can be designed by way of example as a separate and replaceable component placed with a detachable mounting interface (e.g. with a screw connection(s)) directly or indirectly on a brake mount (with an interface to a vehicle axle stub), as illustrated in an exemplary manner in the drawing, or the brake load measuring device is defined without a separate housing component integrated on or in (for example, a cavity of) said brake mount. The housing component may have a housing cavity to accommodate components or parts. The housing component can integrally accommodate one or more sensor means (DMS strain gauges) and a high temperature-tolerant electronics unit (ECU) assigned to the one or more sensor means. In principle, the sensor means and ECU can form separate structural units which are spatially distanced and decoupled from each other, i.e. are provided separately. At the same time, the sensor means and ECU are electrically conductively connected to one another via electrical lines. Alternatively, the sensor means and ECU are spatially combined in such a way that they form a single manageable structural unit. The housing cavity may be designed for any embodiment arbitrarily and by way of example as a blind hole and/or as a through hole, and be arranged largely centrally, aligned and for example centrally between the brake shoes, which is reproduced in such a way or comparably in one embodiment according to the drawing. The housing component may have a blind hole allocated substantially parallel to a wheel rotation axis and a receiving cross bore at right angles (T-shaped) with respect thereto, the orientation of which is substantially centrally flush between the brake shoe supports. The blind hole and the receiving cross bore are oriented orthogonally with respect to each other. The blind hole may open into the through hole.

A housing component of the brake load measuring device, or at least one component of it connected to the ECU, may have an electrical interface. The electrical interface may be located in the area of a brake mount/base. The base can be used, for example, to fix it to an outside of an anchor plate. In the sense of a bridging measure, the housing component may have a housing projection, which is manufactured to be hollow by the blind hole being defined in its center. According to one embodiment, the housing projection engages through a recess of the brake anchor plate (brake stator).

A brake load sensor acting as a piston stop is inserted centrally and in alignment between two pistons (pressure pieces) in the cross-receiving through hole in such a way that the two pistons, in alignment with each other diametrically opposite each other on both sides (boxer motor principle), are seated on both sides of the brake load sensor. Based on the measurement arrangement, with the measuring point arranged centrally aligned between the pistons and integrated in the housing so as to be relatively displaceable, potentially measurement-distorting interference factors such as in particular by way of example zero-point drift and/or zero-point adjustment, component and/or production tolerance, thermal cycling strain influences, friction and/or shear force influences and/or interactions resulting therefrom are automatically compensated for or at least effectively and expediently limited to a tolerable level. In one development, the brake load sensor is amazingly efficiently inserted as a separately replaceable component, such as for example a double-acting piston (feed) stop, in an aligned manner into the center of the receiving cross bore.

A brake load sensor which is implemented may comprise electrical measuring sensors, such as, by way of example, a summarily recording load measuring cell, and support the latter, which further boosts a local/direct measurement which is as uncompromised as possible. For example, a sensor measuring component may be present, which is provided on, at or in the brake load sensor, mounted within the receiving cross bore, and forms, for example, the brake load sensor as such. The brake load sensor may integrate an electric load cell here. Additional effort or a separate structure is rationalized by the brake load sensor being configured, furthermore, as a deformation body with defined elasticity and with defined shaping such as in particular with a defined cross section.

In contrast to known measuring principles, a receiving housing body (bearing block) of the load measuring abutment remains essentially undeformed, whereas a separately defined brake load sensor is present, and wherein a brake load sensor body, in addition to a piston stop function, may at the same time integrate a function as an elastically compliant, i.e. reversibly deformable, elastic element. In other words, the brake load sensor may be understood at the same time as an adaptively interchangeable elastic element, which is inserted so as to be aligned into a force flow of the brake application/braking forces and/or braking torques with efficient adaptation to the needs and brake load boundary conditions of the respective motor vehicle braking system.

Said receiving cross bore in the housing may be configured as a stepped through bore without a bottom. This open design, without a bottom- and starting from a single reference edge-enables, in principle, in conjunction with an improved tolerance situation, all workpiece orientation, component feeding, piston assembly processes, piston insertion processes, etc., to be uniformly directed in a feed-in assembly direction axially (axis A) and from a single outlet side, which improves the modular production.

Component manufacturing and assembly are simplified if the receiving cross bore is of continuous and smooth configuration. In one embodiment with piston insertion from a single end face, a stepped bore with diameter steps tapering successively in the feed direction of the receiving cross bore longitudinal axis (arrow direction) is configured in such a way that receiving cross bore mouths each allocated spaced apart from each other on the end side each form in relation to each other a largest receiving cross bore inner diameter and a smallest receiving cross bore inner diameter of the housing. The result is a substantially undercut-free, continuous receiving bore with production and control that is correspondingly rationalized on one side.

In one development of the construction, it is possible that the receiving cross bore is provided with a closure on the end side, at least in the region of the largest receiving cross bore inner diameter, and wherein the closure has a passage through which the respective piston engages for force or torque transmission. To safeguard against or avoid undesired, uncontrolled disassembly, a bearing can be assigned to one or both pistons. The bearing may be designed in a form-fitting manner by way of example in order to rationalize additional parts or components on the basis of mutual cooperation between mandatory components. In detail, this may be achieved in such a way that each piston is provided with a step or shoulder on the circumferential side for the purpose of a backstop and/or bearing for cooperating with an associated housing counterstop. And the abovementioned receiving cross bore closure may at the same time act, as a dual function, as a bearing for pistons, by the closure forming an indirect or direct stop for a piston.

For measurement precision reasons, aligned and torsion-proof guided mounting of the pistons in the receiving cross bore is recommended. Further, coaxially mounting and centering, of the brake load sensor component (“tethering”) in the different spatial axial directions, such as for example in relation to the pistons is defined. Corresponding anti-rotation safeguard means with piston action or corresponding alignment and centering means serve for these purposes, which are defined, by way of example, between piston and/or piston holder (receiving cross bore) and/or brake load sensor. The anti-rotation safeguard means may beconfigured so as to be form-fitting, whereas the alignment and centering means are configured so as to be form-fitting and/or force-fitting, for example as an elastic element with a spring property. Particularly for example, elastomer elements (O-rings) may be defined in the context of the disclosure of one embodiment for this purpose.

In one development, in order to avoid metallic rattling noise on bad road passages and/or to avoid stop noise due to load change reactions, a backstop and/or bearing can be assigned an elastic element. This elastic element is formed in one specification, by way of example as a spring element. In a standardization or simplification of the construction, this elastic element and/or spring element may be configured as an elastomer body, such as as an elastomer ring, which is mounted on the housing, and/or on the closure and/or on the piston. In order to perfect its damping function, a spring-damper element may as an alternative be present in one development.

A further aspect includes proposals for compact installation space, and improved or maintenance-friendly assembly concepts.

### BRIEF DESCRIPTION OF THE DRAWINGS

Further details of the brake load measuring device are apparent from the following description on the basis of the drawing. In the drawing:

FIG. 1 shows a diagrammatic architecture of an electronic motor vehicle braking system comprising electric drum brakes, which are assigned here purely by way of example to an electrically driven vehicle rear axle,

FIG. 2 shows a highly abstracted overview of the braking system,

FIG. 3 shows, in a scaled down and perspective manner, an electromechanically operated drum brake of the duo servo type without a rotor (brake drum),

FIG. 4 shows the drum brake from FIG. 3 in a side view,

FIG. 5 shows a sectional view with sectional direction C-C as indicated in FIG. 4,

FIG. 6 shows a brake load sensor mounting assembly,

FIG. 7-FIG. 10 show views of a variation of the brake load sensor with a circular cross section,

FIG. 11-FIG. 14 show views of an alternative variation of the brake load sensor with a rectangular cross section,

FIG. 15 shows an exploded drawing of a variation of the brake load sensor with an integrally received load cell,

FIG. 16 shows, in the same way as FIG. 15, an assembled drawing, in perspective,

FIG. 17 shows a cross-sectional view of a variant with an integrally received load cell in electrical connection with a decoupled remote sensor ECU (sECU) for signal processing, and

FIG. 17 a shows a further variation as an enlarged detail with a sensor ECU integrally placed in the area of the load cell for measuring point-allocated electrical primary signal processing,

FIG. 18 shows an alternative embodiment with elastic elements 15,

FIG. 19 shows an embodiment comparable to FIG. 18 with a centered brake load sensor coaxially fixed in relation to the pistons and with elastic elements inserted into a circumferential piston groove,

FIGS. 20-22 show a space-compressed (comparatively narrow dimension X) embodiment based on a housing-integral closure, wherein both pistons are configured with a bearing shoulder, and the pistons are inserted into the receiving cross bore not laterally from one side (FIG. 17) but from centrally on the inside in each case, and

FIGS. 23-25 diagrammatically show one embodiment comprising automatic centering means.

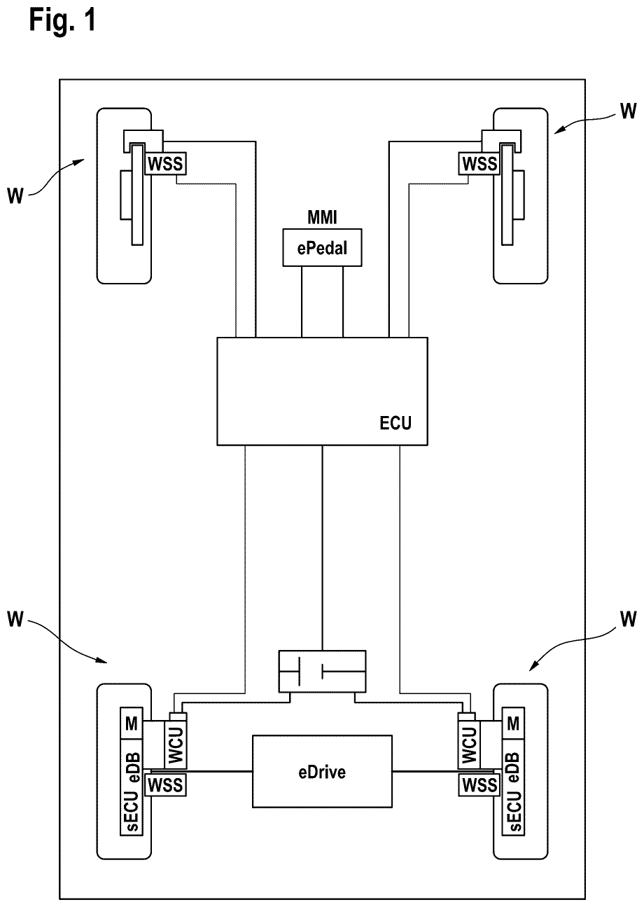

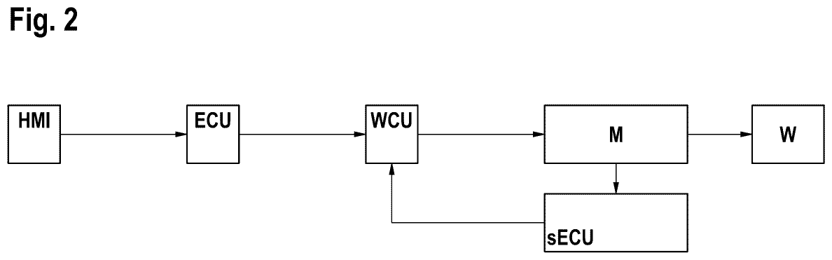

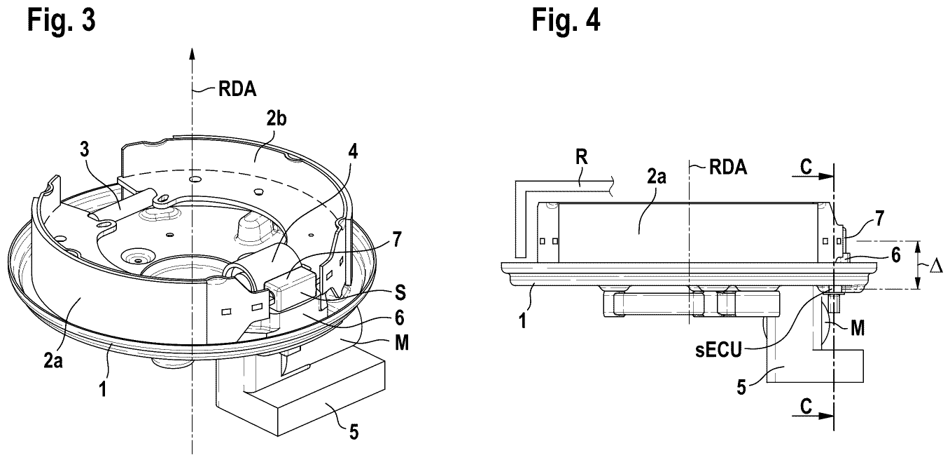

### DETAILED DESCRIPTION

A constructed sensor device for measuring the wheel braking torque in a drum brake is explained. In particular, the brake load measuring device is suitable and intended for electromechanically actuated service brakes in which there is no hydraulic or pneumatic active energy/pressure medium, and therefore no hydraulic/pneumatic controllability is present, sought or required. However, mixed forms are also conceivable in principle and thus fundamentally possible.

The following description of a relevant brake load measuring device is given by way of example and with a focus on the example of a motor vehicle drum brake of the duo servo type. The load may be understood equally as the effective braking torque on the one hand and the effective braking force on the other, depending on the respective task or goal. In principle, the load sensing system described is still equally suitable both for service brakes in duo servo configurations and for simplex drum brakes. The duo servo brake has a high self-boosting action, which makes it possible to generate high braking torques with low actuation forces (reduction in the cost and installation space of the actuator). A challenge of the duo servo brake type is its demanding controllability. Well-known service brakes of the duo servo type suffered from yawing of the vehicle, reduced driving comfort and the like. The present embodiments enable a practicable solution to the problem and requirements in such a way that the special advantages of the duo servo brake for use as a service brake are made possible. A combination of a braking device with an electric parking brake device EPB for producing a combined electric service and parking brake is conceivable.

The integrated brake load sensor system is suitable for simplex drum brakes in order to improve the controllability of the wheel brake. As mentioned above, however, the following statements mainly refer to the application illustrated by way of example in the drawing using a duo servo wheel brake. In a simplex variant, on the other hand, the position of the sensor device changes substantially from directly below or above the spreading device (4) to a fixed brake measuring abutment opposite the spreading device (instead of the adjusting device (3)).

The braking torque is sensed by measuring the supporting force acting from the brake shoe (2a, 2b) on the brake measuring abutment (7). In the case of the duo servo brake, a single-sided force (12a) acts depending on the direction of travel, while in the case of the simplex brake, supporting forces of different magnitude act from both sides at the same time. There is a largely proportional relationship between the measured supporting force and the braking torque.

The sensor device comprises a brake load sensor 8, which is received in a housing 7 by a brake measuring abutment 7a-c. The supporting effect (a resulting braking torque or the supporting force) of the brake shoes is introduced into the brake load sensor 8 via pistons 9a,9b guided in the housing, depending on the braking torque direction. In, at or on the brake load sensor 8 is located a sensor measuring component 13 in the form of a load cell, for example comprising at least one DMS (strain gauge) which senses a resulting elastic deformation of the brake load sensor (resulting deformation) as a measure of the braking force/braking torque. The brake load sensor (supporting element) can be designed as a deformation body, which firstly efficiently introduces the supporting forces into the housing 7 and secondly generates a clear voltage increase for the purpose of measurement using the sensor measuring component 13/DMS. An electrical control unit ECU is assigned to the sensor means for the purposes of measurement signal preparation or measurement signal processing.

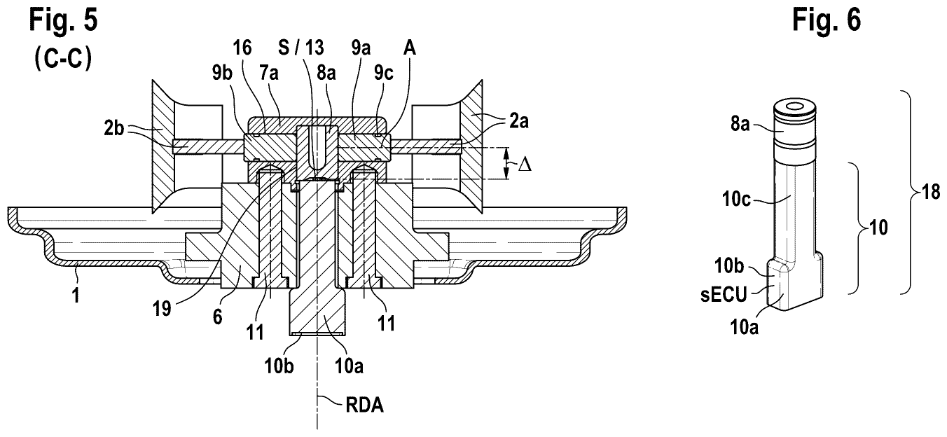

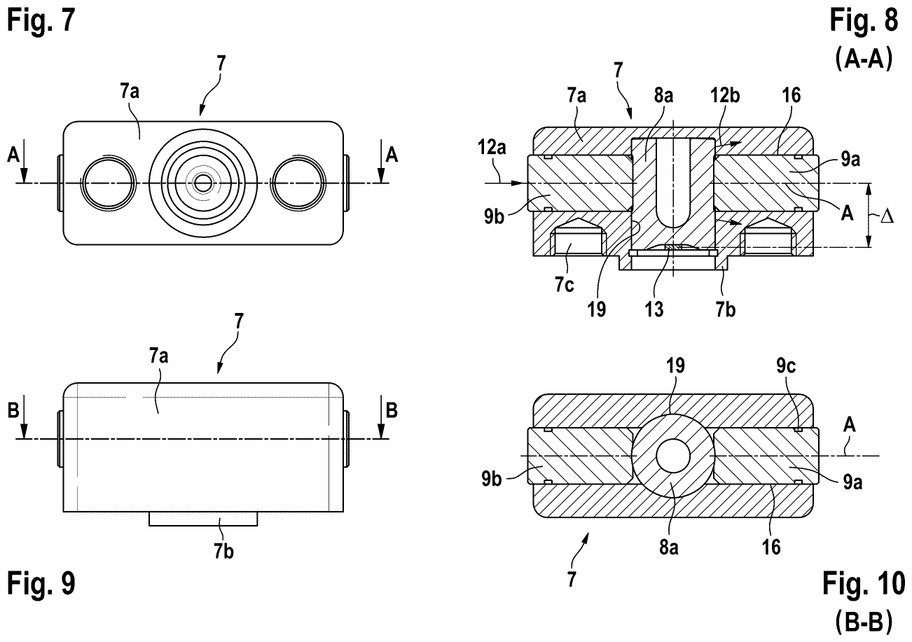

Suitable geometric shapes of the sensor include prismatic bodies which may have cross sections characterized by closed geometry, for example, such as rounded or circular cross-sectional shapes (see 8a) or rectangular cross-sectional shapes (see 8b) and are connected to measuring cell, load cell 8c. The circularly defined cross-sectional shape according to 8a (see FIGS. 5+6) is extended cylindrically as a result and has a bottom on one side. The sensor can be inserted almost directly into a production-compatible receiving cross bore. A rectangular shape according to 8b enables a larger piston contact surface. All sensor embodiments can be adapted to different load levels or conditions by individually adapting their shape (e.g. a wall thickness or the inner contour at 8b), with the result that, depending on the vehicle type, e.g. only the brake load sensor 8 can be replaced as a replaceable component in order to adapt the brake measuring abutment. This makes it possible to make an efficient modular variation for adapting to different applications with as many common parts as possible and with as few special parts as possible-modularity. The same applies to the variant with a load cell. A stop nut 14 is defined here for mounting within the housing. The stop nut has a collar, with the result that it can be screwed in up to the collar during assembly and the desired play with respect to the load cell or the desired preload on the load cell can thus be adjusted. Alternatively, a snap ring is also conceivable, but it is not as durable as a screw-in nut.

The brake load sensor 8 can be pressed into the housing or mounted therein with play. A clearance fit allows that temperature-related strains do not generate a force on the brake load sensor and thus do not generate undesired measurement signals. An O-ring seal 9c is provided on the pressure pieces for sealing purposes, and also prevents the pressure pieces from falling out of the housing during the assembly process. Alternatively or in addition, an externally arranged and statically loaded sealing means (e.g. bellows seal) and/or a dynamically loaded sealing means (rod seal) or seal variations thereof or seal equivalents thereto are conceivable.

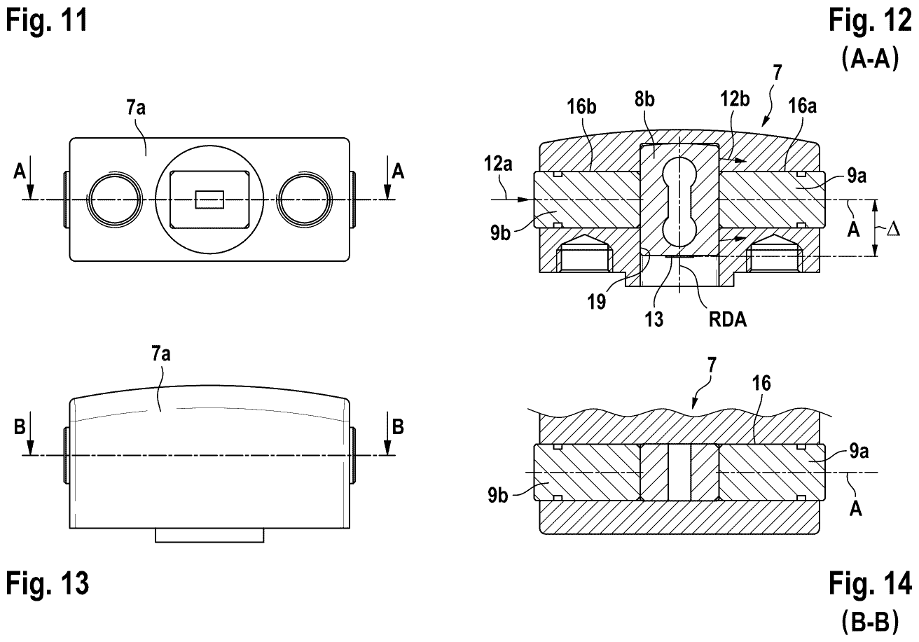

The brake load sensor 8 (for example comprising a load cell, DMS or the like) and/or the sensor electronics sECU can in principle be arranged integrally in the housing 7 having the brake measuring abutment 7a, 7b, 7c in a manner which is received aligned between the brake shoes 2a,2b. The brake measuring abutment 7 is therefore in turn located in a drum brake interior, which, in intended operational use, is covered by a brake rotor, namely by the brake drum (not illustrated). In other words, the encapsulation effect of the brake drum makes necessary cooling difficult. During braking operation, heat can accumulate if the interior of a drum brake, for example as a result of continuous braking, heats up greatly, which could damage sensitive sensor electronics. In order to remedy this situation, an inserted offset+transmission means can be present using the brake load sensor components (8a) and (8b), as is the case by way of example according to the illustrated embodiment in FIGS. 5, 8 and 12. This acts as a decoupling means, which makes it possible to offset an electrical-sensor part 13/sECU of the brake load sensor 8 at a distance from the axis A, namely in the axial direction of the “cool” exterior area of the drum brake (i.e. moving it out of an interior area covered by the brake drum and offset rearward axially outward-namely at the rear, behind the brake anchor plate/stator 1). In order to move a measuring electronics system, which is sometimes designed to be very sensitive to temperature, even further outward into the thermally favorable exterior area, this can be moved outward via a housing (10) connected to the brake load sensor (10b). The housing can be molded or clipped, for example, to the brake load sensor and can have an integrated electrical connection between the DMS and electronics (10c) (e.g. leadframe, conductor track, cable) and can directly have a plug/socket (10a) for connection to the WCU (Wheel Control Unit) (alternatively, a plug-free connection to the WCU is also conceivable). This embodiment enables a series-suitable assembly in which the brake load sensor system, together with the evaluation electronics and the plug, can be inserted “from below” into the brake assembly as a pre-assembled assembly (18).

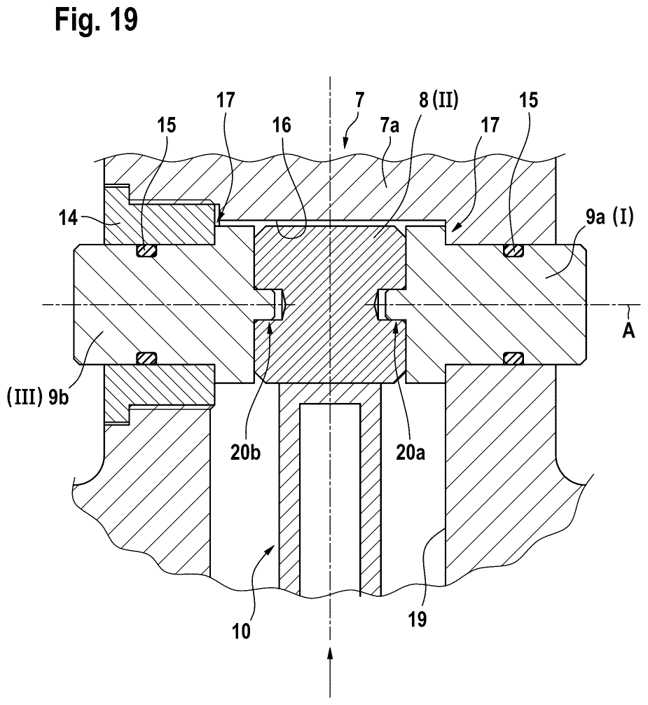

The sensor design is also suitable for reducing the “clicking noise” (noise that occurs when the brake shoes suddenly move from one supporting side to the other). It is recommended to this end for at least one damping element-see elastic element 15 in various design options—to be inserted in the flow of force, between the force-loaded pistons and the housing (7). The damping element (e.g. elastic element, elastomer ring, 15) may, for example, lie in the flow of force between the piston 9a,9b and housing (as shown in FIG. 19, 19) or be inserted between the piston 9a,9b and the brake load sensor 8a,b,c. In a further embodiment, a damping means between the piston 9a,b and brake shoe 2a,b is conceivable

One embodiment consists in mounting the brake load sensor-especially in an embodiment with a load cell 13—within the housing in a preloaded manner. In principle, i by way of example, all elastic elementseg. plate, shaft and/or elastomer spring means, which are positioned between the piston 9a, 9b and housing, are suitable to this end. A defined preload of said elastic element is suitable: firstly, a defined preload of a load cell (preload offset=>filter-like effect=>increased measuring accuracy) and, secondly, a backlash-free installation position of a measuring cell (exclusion of excitation or exclusion of parasitic measuring cell movement due to vibration). Tolerances and temperature-induced length changes can be compensated for by damping or suspension without an overload or strong interference signals of the brake load sensor occurring.

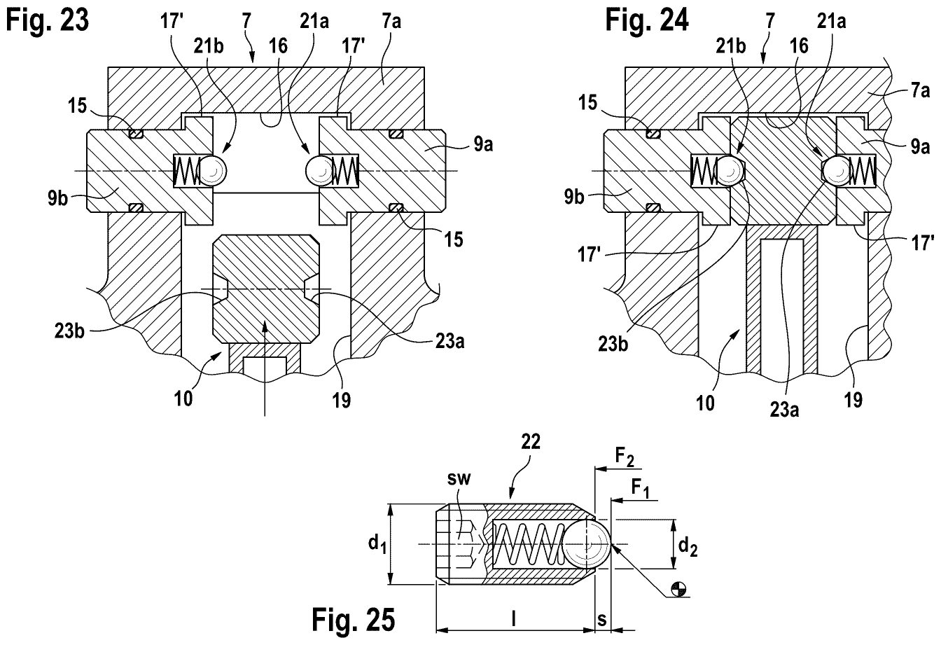

As an alternative for centering means 20a,b presented as being form-fitting, with cams and a cavity on the components piston 9a,b and brake load sensor 8a,b,c, as according to the disclosure content of the embodiment according to FIG. 19, it is possible according to modified embodiments according to the model of FIGS. 23-25 to provide automatic centering means 21a,b,. Each automatic centering means 21a,b can therefore be present as a separate machine element (resilient pressure piece), which can be fixed to one of the components in an adjustable manner, and to this end has a separate body with a spring-loaded pressure body-such as, for example, a spring-loaded ball as a pressure head—and wherein the pressure body is suitable and intended for engaging in a spring-loaded manner into an assigned cavity 23a,b on the assigned component (the one to be centered), with the result that, after component assembly, a releasable prestressed arrangement with a form fit and a force fit automatically results by way of interaction. To this end, the cavity has by way of example a butted, spherical-dome-shaped or otherwise geometrically profiled shape configuration for interaction with the pressure body, in order that the abovementioned automatic centering property is assisted. Each of the pistons 9a,b can have its own resilient pressure piece as shown, in order to enable self-adjusting and automatic snap-in centering by way of interaction with the brake measuring component fed in the direction of assembly.

It must be added that, in principle, centering means 20a,b are recommended for arranging between the receiving housing of the brake measuring abutment 7, piston 9a,b and the brake load sensor 8a,b,c or its components, such as by way of example according to the model of the embodiment according to FIG. 19. In order to enable an arrangement which is as precise as possible and coaxially aligned concentrically with respect to the axis A, for example, a mutually stepped form-fitting arrangement may for this purpose be such that at least one coaxially provided and protruding pin is present on at least one of the paired components, which pin is suitable and intended for engagement into an associated depression on a counter-component. In particular, according to FIG. 19, each piston 9a,b can be provided by way of example with a central centering pin, which engages in a central centering recess of the brake load sensor 8. In principle, the arrangement may also be arranged in an inversely swapped manner, or alternatively, a mixed form can be configured, for example, by a piston 9a serving by way of a centering recess for receiving a centering pin, which emanates from the brake load sensor, and wherein, secondly, the brake load sensor may have a centering recess on its left-hand side, into which a centering pin of the piston 9b can engage.

Further modified embodiments of the centering means are possible. For example, and as an alternative to centering pins, one or possibly both of the pistons 9a,b may be provided with a resilient pressure piece as per FIG. 23, with the result that, with the insertion of said brake load sensor 8 between the two pistons 9a,b, a suitable centering position and positionally secure clamping between the pistons 9a,b is produced automatically.

For increased measuring precision, it is recommended to mount the pistons 9a,b in the brake measuring abutment 7 in a torsion-proof manner. This avoids undesired rotation of the pistons 9a,b. An undesired piston rotation could be caused, for example, if there is a slightly displaced, in particular off-center contact or force action/support on the piston 9a,b. A form-fitting anti-rotation safeguard means between the closure element 14 and the piston 9b engaging through here can be produced. To this end, for example, a form-fitting means (“lug”) molded onto the inner side of the closure element 14 (and facing toward the load cell 13) engages into a corresponding recess on a piston collar and thus secures the rotation of the piston 9b relative to the closure element 14. The closure element 14 may be firmly connected to the receiving housing of the brake measuring abutment 7 via a thread in a frictionally locking manner. Alternatively, a form-fitting anti-rotation safeguard means directly between the piston 9a,b and housing is also possible, by way of example for the piston 9a.

As can be seen in an exemplary manner with reference to FIG. 19, an achievable measurement precision is increased by defining the alignment of the brake load sensor 8 based on centering means between the pistons 9a,b. As an alternative for the centering means 20a,b presented as being form-fitting, with cams and a cavity on the components pistons 9a,b and brake load sensor 8a,b,c, as according to the disclosure content of the embodiment according to FIG. 19, it is possible according to modified embodiments according to the model of FIGS. 23-25 to provide automatic centering means 21a,b. Each automatic centering means 21a,b can therefore be present as a separate machine element (resilient pressure piece), which can be fixed to one of the components in an adjustable manner, and to this end has a separate body with a spring-loaded pressure body-such as, for example, a spring-loaded ball as a pressure head—and wherein the pressure body is suitable and intended for engaging in a spring-loaded manner into an assigned cavity 23a,b on the assigned component (the one to be centered), with the result that, after component assembly, a releasable prestressed arrangement with a form fit and a force fit automatically results by way of interaction. To this end, the cavity has by way of example a butted, spherical-dome-shaped or otherwise geometrically profiled shape configuration for interaction with the pressure body, in order that the abovementioned automatic centering property is assisted. Each of the pistons 9a,b can have its own resilient pressure piece as shown, in order to enable self-adjusting and automatic snap-in centering by way of interaction with the brake measuring component fed in the direction of assembly.

Furthermore, it must be added that the proposed brake load sensor 8a,b,c, or components thereof, in relation to a defined axis A given in alignment between the brake shoes 2a, 2b with a distance A, can be provided such that it is/they are set back rearward axially in the housing of the brake measuring abutment 7 in such a way that the brake load sensor 8a,b,c, or at least its sensitive components, such as in particular a load cell 13 and/or electronics sECU, is/are given (thermal) component protection by way of insulation, air gap or the like.

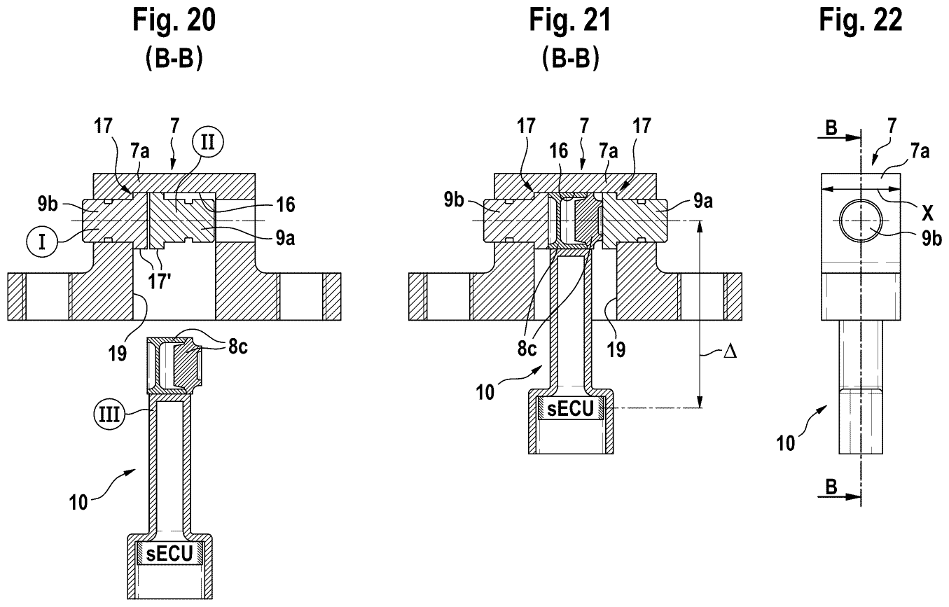

FIGS. 20-22 also illustrate a compressed and also rationalized construction of a housing 7. Fundamentally, there is a criticality of the overall size and a general need for miniaturization for all installation components. A housing width X is particularly critical here, with the result that there is the secondary task of minimizing the dimension X. The embodiment make a contribution to this and also enables differently varied methods for the purpose of component assembly.

Firstly, an component assembly process is made possible, which can be automated and monitored with reliability, since the installation component feed takes place exclusively from a single side (starting from below and through the receiving longitudinal bore). “Below” is to be understood accordingly here, and refers here only to the exemplary graphic representation, wherein this may also be otherwise rotated in reality and depending on the structure of the respective mechanical production plant.

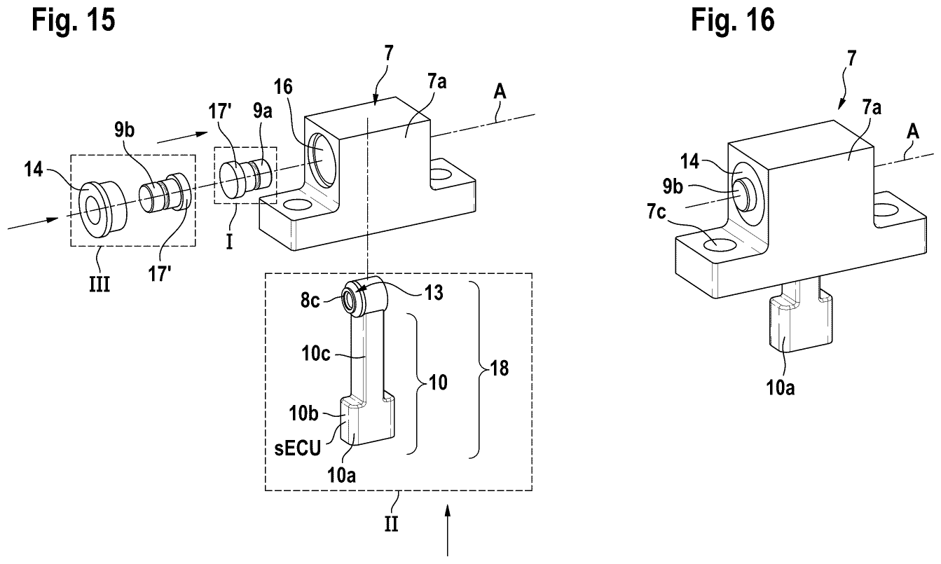

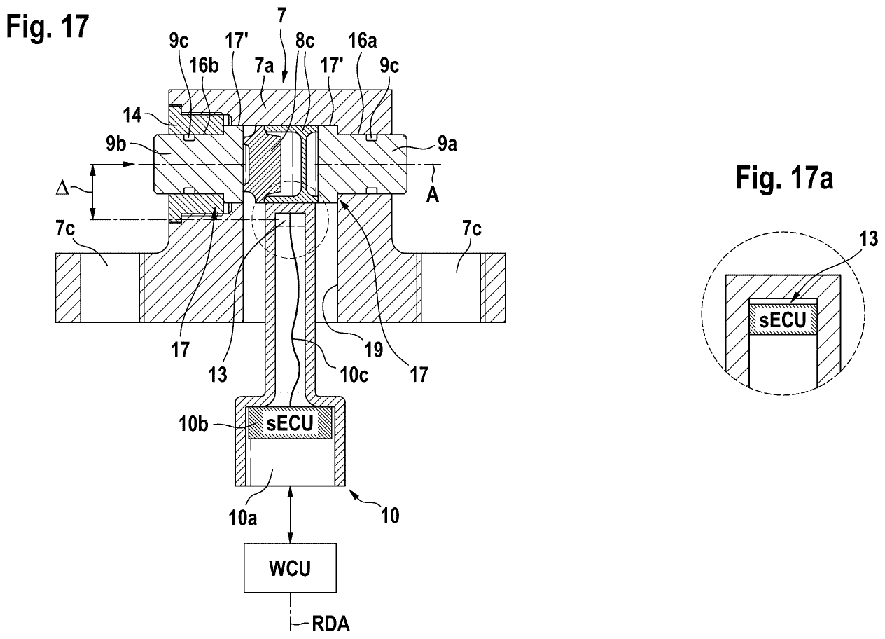

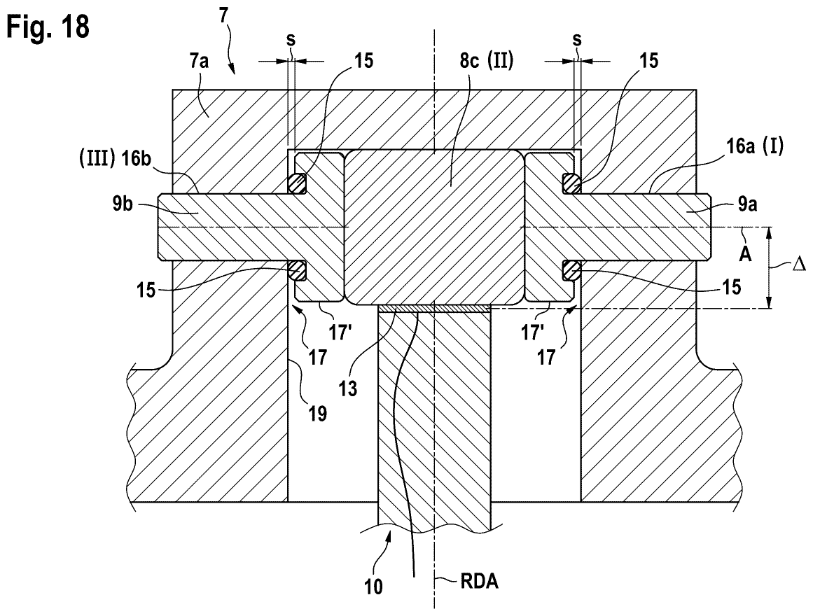

A component assembly concept provided so as to be largely replacement-friendly and/or maintenance-friendly is apparent by way of example from FIG. 15. The exploded drawing according to FIG. 15 shows the sequence of stages I, II and III, wherein, in contrast to another, alternative construction, action is taken from two sides (in FIG. 15 from the left and from below), and wherein the installation components are supplied and mounted separately from the two different sides. The construction and assembly procedures which are arranged such that they are comparatively replacement-friendly and thus resource-conserving make it easy, by way of example, to replace defective brake load sensors/load cells without pistons 9a,b having to be removed for this purpose.

An alternatively developed construction and assembly method is based, in contrast, on a component feed acting on one side according to the procedure as per the example of FIGS. 20-22. This component handling is carried out here exclusively on one side and from “below” (position information must be interpreted accordingly and depending on the construction of the respectively selected industrial production line) through the receiving longitudinal bore 19 which is open “below” on one side. Based on a symbolized assembly sequence based on the sequence of stages I, II and III, starting in step I, the piston 9b is first of all fed through the receiving longitudinal bore 19 open at the “bottom” and inserted into the receiving cross bore 16. With step II, the corresponding process is likewise performed “from below” in a mirror-inverted manner for the piston 9a. With step III, a brake load sensor assembly 8 is finally inserted into its intended installation space “starting from below” through the receiving longitudinal bore 19 in the alignment of the receiving cross bore 16 between the two pistons 9a,9b. As a result, a receiving housing 7 can be of narrower construction (dimension X is minimized) or, if the housing size is the same, it is made possible for a lower-cost sensor system/load cell with a larger installation space requirement (e.g. larger outer diameter) to be used.

The main technical features of the embodiments can be summarized by way of example as follows:
due to the central, centrally aligned clamping/arrangement between the brake shoes, only one load cell 13 is required to detect the resulting braking force/effective braking torque per wheel brake (rationalization)
compressed, compact design (miniaturization)—see, for example the embodiment according to FIGS. 20-22
suitable for detecting high application forces/braking torques (robust)
reduced number of parts with simplified construction (simple)
with the configuration of a clearance fit between the housing and the brake load sensor 8, temperature-induced strains are decoupled from the load (force measuring) cell 13 (reduced interference factors)
modular (pre-) assembly as well as (pre-) testing of a brake sensor assembly is made possible
brake load sensor system S can be received in an integrated manner in the housing with high temperature-tolerant electronics (sECU)—it is also likewise offered as an alternative to provide ECU+sECU moved so as to be at a distance with an offset A in a “cool” exterior area (i.e. thermal insulation and heat-decoupled construction possible)
by means of brake load sensors which can be of different configuration (characteristic key component) with an otherwise identical design, scalability for different vehicle applications, load levels, vehicles etc. is made possible (efficiently variable design/cost-sensitive modular system possible)
symmetrical force introduction into the brake load sensor is ensured individually via identical pistons guided freely axially in a sliding manner—this ensures an axial, “clean” force introduction (with lateral forces compensated for) and measurement even with brake shoes seated in a slightly oblique or offset manner (robust measuring principle)
defined interface for a direct, uninterrupted largely one-piece looped-through electrical connection—as desired as far as a wheel brake control unit WCU or as far as a central brake control unit ESP-ECU-good electrical contact/reduced risk of micro-fretting

1. A brake load measuring device for a motor vehicle brake comprising:
a housing having a plurality of brake measuring abutments, wherein the housing is arranged non-rotationally and in alignment between two brake shoes, and which serves as a bearing for the brake shoes which are arranged spaced apart and diametrically opposite one another, wherein the housing defines a cross bore which is arranged aligned with respect to lateral brake shoe supports;
two pistons are spaced apart from one another and coaxially movably guided in the cross bore, on each of which one of the brake shoes is seated; and
a brake load sensor assembly including a brake load sensor wherein the brake load sensor is inserted centrally into the cross bore as a piston stop and in alignment between the pistons in a displaceable manner such that the pistons are seated on the brake load sensor in alignment and diametrically opposite each other.

2. The brake load measuring device as claimed in claim 1, wherein the brake shoes, clamp the brake load sensor between one another, indirectly via the pistons, with an elastic preload force at least in a released brake state.

3. The brake load measuring device for a motor vehicle brake as claimed in claim 1, wherein the brake load sensor comprises a sensor measuring component which is one of multiple separate components and integral to the brake load sensor, wherein the sensor measuring component is a load cell.

4. The brake load measuring device for a motor vehicle brake as claimed in claim 1, wherein the brake load sensor has an elastic spring body.

5. (canceled)

6. The brake load measuring device for a motor vehicle brake as claimed in claim 1, wherein the brake load sensor-assembly is mounted in one of: a longitudinal bore defined by the housing and the cross-bore.

7. The brake load measuring device for a motor vehicle brake as claimed in claim 3, wherein the sensor measuring component is provided on, at or in the brake load sensor within the cross bore.

8. (canceled)

9. The brake load measuring device for a motor vehicle brake as claimed in claim 1, wherein the brake load sensor is a deformation body with defined elasticity and with defined shaping.

10. (canceled)

11. The brake load measuring device for a motor vehicle brake as claimed in claim 1, wherein the cross bore of the housing is a through bore without a bottom.

12. The brake load measuring device for a motor vehicle brake as claimed in in claim 11, wherein a diameter of the cross bore tapers along a longitudinal axis of the cross bore such that cross bore mouths defined on opposing ends of the housing are spaced apart from each other one having a largest cross bore inner diameter and the other having a smallest cross bore inner diameter.

13. The brake load measuring device for a motor vehicle brake as claimed in claim 12, further comprising a closure is provided for the cross-bore mouth with the largest cross bore inner diameter and wherein the closure defined a passage which is penetrated by one of the pistons.

14. The brake load measuring device for a motor vehicle brake as claimed in claim 1, wherein at least one of the pistons has a bearing, for disassembly protection in the housing.

15. The brake load measuring device for a motor vehicle brake as claimed claim 14, wherein the bearing is form-fitting and encloses a stop on at least one of the pistons and the housing.

16. The brake load measuring device for a motor vehicle brake as claimed in claim 14 wherein the bearing is present on the circumference of the piston and is one of a projection, step and shoulder, which cooperates in a form-fitting manner with an associated abutment.

17. The brake load measuring device for a motor vehicle brake as claimed in claim 14, wherein the bearing comprises a component which can be separately mounted on the piston, wherein the bearing is a snap ring.

18. The brake load measuring device for a motor vehicle brake as claimed in claim 14, wherein the bearing comprises a component which can be separately mounted on the housing, wherein the bearing is a closure.

19. The brake load measuring device for a motor vehicle brake as claimed in claim 14 wherein the bearing is assigned an elastic element.

20. The brake load measuring device for a motor vehicle brake as claimed in claim 19, wherein the elastic comprises an elastomer ring.

21. The brake load measuring device for a motor vehicle brake as claimed in claim 19, wherein the elastic element is provided on at least one of the housing, the closure the piston, and the brake load sensor.

22. The brake load measuring device for a motor vehicle brake as claimed in claim 1, wherein the piston is assigned at least one anti-rotation safeguard means in order to avoid undesired rotation adjustment.

23. The brake load measuring device for a motor vehicle brake as claimed in claim 22, wherein the anti-rotation safeguard is directly or indirectly between one of: the housing and the piston, the brake load sensor and the piston; and the closure and the piston.

24-25. (canceled)

26. The brake load measuring device for a motor vehicle brake as claimed in claim 22, wherein the anti-rotation safeguard acts on the piston in a form-fitting manner, in order to avoid a relative rotation of the piston.

27. (canceled)

28. The brake load measuring device for a motor vehicle brake as claimed claim 1, further comprising at least one centering means element is provided between the piston and the brake load sensor.

29. The brake load measuring device for a motor vehicle brake as claimed in claim 1, wherein the brake load sensor is offset axially rearward of the brake measuring abutment to provide protection for the brake load sensor.

30-34. (canceled)

35. The brake load measuring device for a motor vehicle brake as claimed in claim 1, wherein, the motor vehicle brake is a drum brake which is one of a vehicle service brake and a vehicle combination brake, which additionally has an electric parking brake.

36. The brake load measuring device for a motor vehicle brake as claimed in claim 1, wherein, the motor vehicle brake is a drum brake which is one of a simplex brake, a servo brake, and a dual-mode drum brake.

37. A method of assembling a brake load measuring device comprising:
inserting a first piston assembly into a first opening to a cross bore defined by a housing;
inserting a mounting assembly into second opening to a longitudinal bore defined by the housing, wherein the longitudinal bore perpendicularly intersects with the cross bore and a brake load sensor of the mounting assembly is located in the cross-bore after mounting assembly is inserted; and
inserting a second piston assembly into the first opening such that the brake load sensor is located between the first piston assembly and the second piston assembly.

38. A method of assembling a brake load measuring device comprising:
inserting a first piston assembly into an opening to a longitudinal bore defined by a housing;
sliding the first piston assembly within a cross-bore defined by the housing which perpendicularly intersects with longitudinal bore;
inserting a second piston assembly into the opening to a longitudinal bore defined by a housing;
sliding the second piston assembly within the cross-bore in a traverse direction from the first piston assembly; and
inserting a mounting assembly into the opening such that a brake load sensor of the mounting assembly is located between the first piston assembly and the second piston assembly.
